(19) United States
(12) Patent Application Publication
(10) Pub. No.: US 2015/0274531 A1
(43) Pub. Date: Oct. 1, 2015

(54) Method for Forming Graphene Oxide

(71) Applicant: GRAPHENEALL CO., LTD, Bundang-gu, Seongnam-si, Gyeonggi-do (KR)

(72) Inventor: Yeo Heung Yoon, Asan-si (KR)

(73) Assignee: GRAPHENEALL CO., LTD., Suwon-si, Gyeonggi-do (KR)

(21) Appl. No.: 14/434,678

(22) PCT Filed: Oct. 10, 2013
(86) PCT No.: PCT/KR2013/009043

§ 371 Date: Apr. 9, 2015

(30) Foreign Application Priority Data
Oct. 9, 2012 (KR) 10-2012-0112103

(51) Int. Cl. C01B 31/04

(52) U.S. Cl. CPC C01B 31/043

(57) ABSTRACT

Graphite is oxidized using an acid so as to form a first reaction product that comprises graphene oxide. The acid is recovered from the first reaction product. Graphite is oxidized using the recovered acid so as to form a recycle-reaction product that comprises graphene oxide.

### TECHNICAL FIELD

One or more embodiments of the present disclosure relate to a method of forming graphene oxide, and more particularly, to a method of forming graphene oxide using an acid.

### BACKGROUND ART

Recently, research into graphene with useful mechanical and electrical characteristics has been performed in various aspects. Accordingly, research has been conducted into various processes for obtaining graphene oxide from graphite source material.

In forming graphene oxide through oxidation process of graphite, conventional methods that have been suggested so far take so much time that a large amount of acid may penetrate into the final graphene oxide product after synthesis of the final grapheme oxide product. This makes it difficult to separate the acid from the final graphene oxide product. Furthermore, such large amount of acid discarded after use in the synthesis of graphene oxide may adversely affect the environment.

### DETAILED DESCRIPTION OF THE INVENTION

### Technical Problem

The present invention provides a method of forming graphene oxide, the method taking comparatively short time, and ensuring easy separation of an acid from the final graphene oxide product and consequently reducing a waste ratio of toxic byproducts such as acid.

### Technical Solution

One or more embodiments include a method of forming graphene oxide, the method including oxidizing graphite using an acid so as to form a first reaction product that comprises the graphene oxide. The acid is recovered from the first reaction product. Graphite is oxidized using the recovered acid to form a recycle-reaction product that includes the graphene oxide.

At least one of the forming of the first reaction product and the forming of the recycle-reaction product may include: a first oxidization step of oxidizing graphite at a first temperature that does not exceed 50° C.; and a second oxidization step of oxidizing the graphite while applying microwaves.

In the forming of the first reaction product, the graphite may be oxidized using the acid and an oxidant to form the graphene oxide. In the forming of the recycle-reaction product, the graphite may be oxidized using the recovered acid and a newly added oxidant to form the graphene oxide. One or more embodiments includes a method of forming graphene oxide, the method including: forming the graphene oxide by oxidizing graphite in a mixed solution that includes an acid solution and the graphite while applying microwaves to the mixed solution; and a second step of forming graphene oxide by oxidizing newly supplied graphite using the acid solution recovered from a resulting product of the first step, wherein the second step comprises alternately repeating a recovery step of recovering the acid solution from the resulting product of a preceding step, and a recycling oxidation step of forming the graphene oxide by oxidizing newly supplied graphite while applying microwaves to a mixed solution that includes the recovered acid solution and the newly supplied graphite.

### Advantageous Effects

As described above, according to the one or more embodiments of the present disclosure, a graphene oxide formation method may reuse an acid solution that was recovered after used in a preceding graphite oxidation process in a subsequent oxidation process of newly supplied graphite. Accordingly, the consumption of acid in the entire graphite oxidation process may be remarkably reduced, and consequently the productivity of graphene oxide may be improved.

### DESCRIPTION OF THE DRAWINGS

FIG. 1 is a flowchart for describing a method of forming graphene oxide according to embodiments of the present disclosure;

FIG. 2 is a flowchart for describing exemplary graphite oxidation processes of oxidizing graphite in a graphene oxide forming method according to embodiments of the present disclosure;

FIG. 3 is a flowchart for describing exemplary methods of performing a recycling process in a graphene oxide forming method according to embodiments of the present disclosure;

FIG. 4 is a schematic view of a graphene oxide forming apparatus according to an exemplary embodiment for forming graphene oxide according to embodiments of the present disclosure;

FIGS. 5A to 5E are graphs for describing various methods of applying microwaves to a mixed solution in a graphene oxide formation process in a method of forming graphene oxide according to embodiments of the present disclosure.

FIGS. 6A to 6C illustrate the results of X-ray diffractometry (XRD) on graphene oxide obtained by an exemplary method according to Preparation Example 1;

FIG. 7 illustrates the results of thermogravimetric analysis (TGA) on the graphene oxide obtained by the exemplary method according to Preparation Example 1;

FIG. 8 illustrates the results of XRD on an 8^{th} graphene oxide product obtained in Preparation Example 1;

FIG. 9 illustrates X-ray photoelectron spectroscopic (XPS) spectra of the 8^{th} graphene oxide product obtained in Preparation Example 1; and

FIG. 10 illustrates Fourier transform infrared (FT-IR) spectra of the 8^{th} graphene oxide product obtained in Preparation Example 1.

### BEST MODE

The invention now will be described more fully hereinafter with reference to the accompanying drawings, in which illustrative embodiments of the invention are shown. Like numbers refer to like elements throughout, and descriptions of such like or same elements will not be repeated.

This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

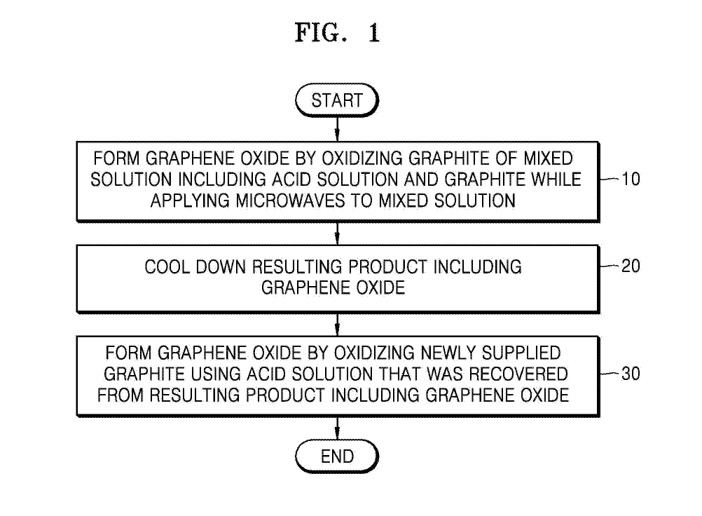

FIG. 1 is a flowchart for describing a method of forming graphene oxide according to embodiments of the present disclosure.

Referring to FIG. 1, in a process 10, graphene oxide may be formed by oxidizing graphite of a mixed solution including an acid solution and the graphite while applying microwaves to the mixed solution.

The mixed solution may further include an oxidant. In the process 10 of graphite oxidation, graphite may be oxidized with the acid solution and an oxidant.

In some embodiments, the acid solution may include at least one selected from sulfuric acid, phosphoric acid, sodium nitrate, potassium persulfate, phosphorus pentoxide, chlorosulfonic acid, fluorosulfonic acid, oleum, and acetic acid.

In some embodiments, the oxidant may be selected from permanganate, ferrate, osmate, ruthenate, chlorate, chlorite, nitrate, osmium tetroxide, ruthenium tetroxide, lead dioxide, hexavalent chromium ions (CrO₃⁻, Cr₂O₇⁻, chromate, dichromate, and pyridinium chlorochromate (PCC)), hydrogen peroxide (H₂O₂), silver oxide (Ag₂O), ozone (O₃), and a combination thereof. For example, the oxidant may be potassium permanganate.

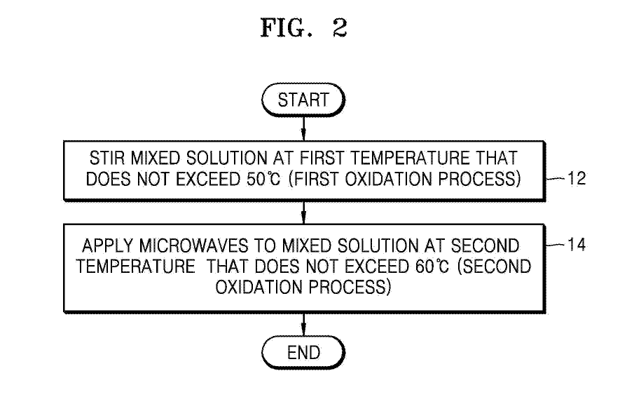

FIG. 2 is a flowchart for describing methods of performing a graphite oxidation process in process 10 of FIG. 1 according to embodiments of the present disclosure.

Referring to FIG. 2, to perform graphene oxidation in the process 10, a first oxidation process (process 12) and a second oxidation process (process 14) may be sequentially performed.

The first oxidation process (process 12) may include stirring the mixed solution at a first temperature that does not exceed 50° C. First, the first oxidation process may be performed at a temperature of about 5° C. to about 10° C. The first oxidation process may be performed for about 1 minute to about 60 minutes. In some embodiments, the first oxidation process time may do not exceed 10 minutes. The first oxidation process is an initial oxidation step for forming graphene oxide. When the reaction temperature of the initial oxidation step is too high, an explosion is likely to occur due to a sudden and rapid oxidation reaction. To eliminate such explosion potential, the reaction temperature of the first oxidation process may be maintained at a temperature of about 50° C. or lower.

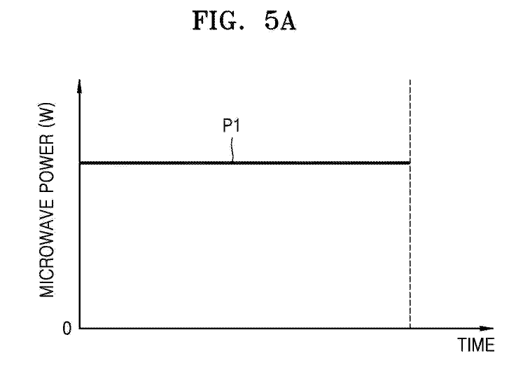

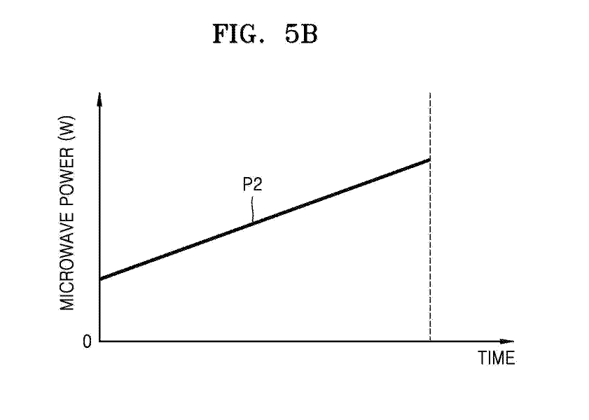

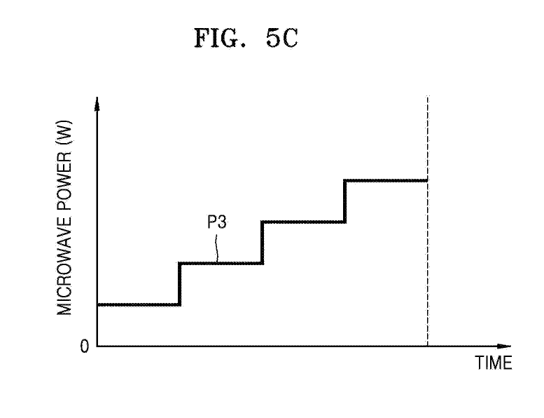

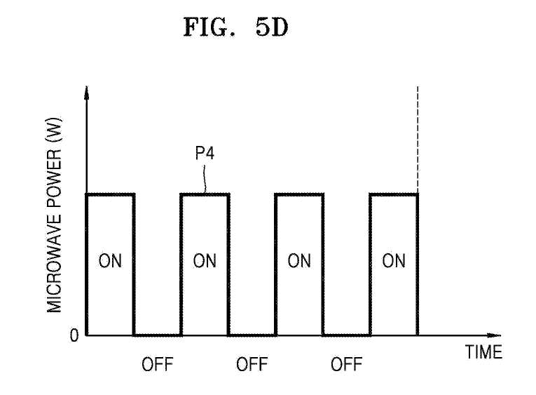

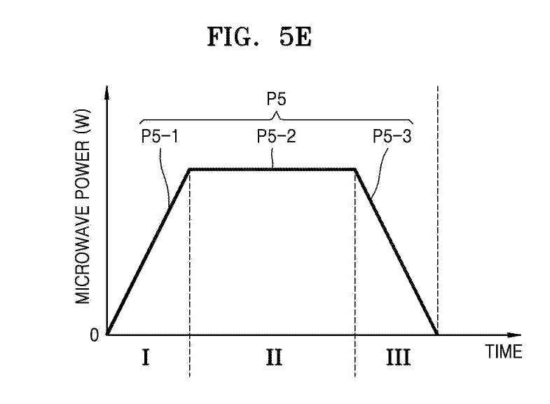

The second oxidation process (process 14) may include applying microwaves to the mixed solution at a second temperature that does not exceed 60° C. For example, the second oxidation process may be performed at a temperature of about 20° C. to about 50° C. In some embodiments, the second oxidation process may be performed for about 1 minute to about 60 minutes. When the temperature of the mixed solution rises too high, this may cause unwanted reduction reaction of the graphene oxide synthesized from the mixed solution. To prevent the reduction of the graphene oxide obtained from the mixed solution, the temperature of the mixed solution needs to be effectively controlled during the second oxidation process. To effectively control the temperature of the mixed solution during the second oxidation process, microwaves may be applied to the mixed solution in various ways. In some embodiments, in the second oxidation process, microwaves of about 100 W to about 800 W may be applied to the mixed solution of an acid solution and graphite. Methods of applying microwaves to oxidize graphite in the second oxidation process will be described later in greater detail with reference to FIGS. 5A to 5E.

In a graphite oxidation process for forming graphene oxide, the time it takes to oxidize graphite may be shortened through a microwave application process. When the time it takes to oxidize graphite is too long, a strong acid used in the graphite oxidation reaction may permeate deeply into layers of graphite. The longer the oxidization reaction time becomes, the more difficult becomes a process of recovering the acid from graphene oxide obtained as a reaction product after termination of the oxidation reaction. For these reasons, the shorter time of the graphite oxidation process for forming graphene oxide may be advantageous. In some embodiments, in the graphite oxidation process for forming graphene oxide, the time it takes for the graphite oxidation reaction may be reduced by applying microwaves, and consequentially it may also be easy to recover the acid from the reaction product.

As a result of oxidizing graphite according to the process 14, graphene oxide having a structure that includes several to tens layers of sp² hybridized carbon sheet may be obtained. For example, the graphene oxide that results from the process 14 may have a structure that includes about 1 to 10 layers of sp² hybridized carbon sheet.

Referring back to FIG. 1, in a process 20, the oxidation reaction product obtained from the process 10 may be cooled.

In some embodiments, to cool the oxidation reaction product obtained from the process 10, the oxidation reaction product may be cooled down to room temperature, and then poured onto ice together with hydrogen peroxide (H₂O₂). For example, in the process 20, the oxidation reaction product obtained from the process 10 may be cooled down to a temperature of about 10° C. to about 40° C.

In a process 30, newly supplied graphite may be oxidized using the acid solution recovered from the resulting product of the process 20 to form graphene oxide. The process 30 is a recycling process reusing the acid solution that was used at least one time to form graphene oxide.

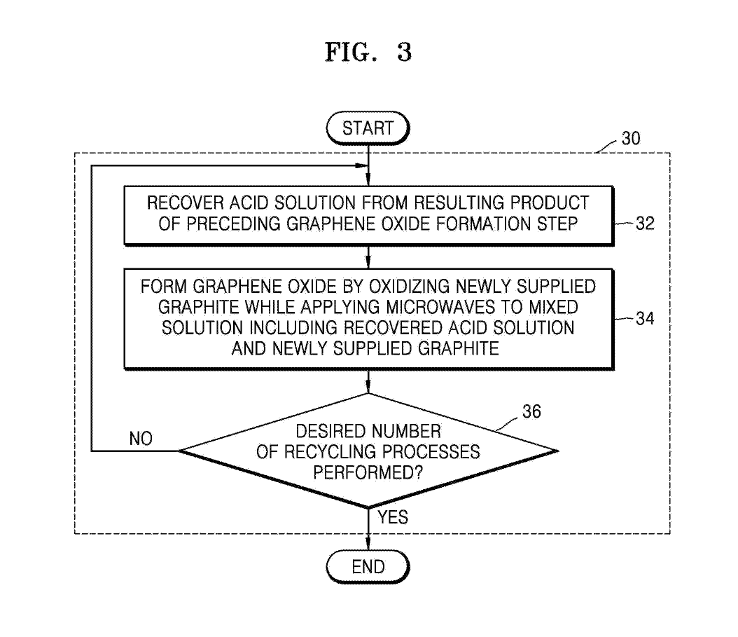

FIG. 3 is a flowchart for describing exemplary methods of performing the recycling process 30 of FIG. 1 in graphene oxide forming methods according to embodiments of the present disclosure.

Referring to FIG. 3, in a process 32, the acid solution may be recovered from the resulting product of the preceding graphene oxide formation process. For example, the acid solution may be recovered from the resulting product of the process 20 of cooling the resulting product of the process 10 in FIG. 1 that includes graphene oxide.

In some embodiments, the acid solution may be recovered from the resulting product of the process 20 by using centrifugation. For example, after centrifuging the resulting product of the preceding graphene oxide formation process, the resulting supernatant except for the precipitate may be recovered and used as a recycled acid solution.

In some other embodiments, the acid solution may be recovered from the resulting product of the process 20 by using filtering. For example, after filtering the resulting product of the preceding graphene oxide formation process through a filter, the resulting filtrate except for the unfiltered residue may be recovered and reused as a recycled acid solution.

In still other embodiments, the acid solution may be recovered from the resulting product of the process 20 by using a dialysis membrane. For example, after the resulting product of the process 20 is put into a dialysis membrane that is able to selectively pass only an acid, the dialysis membrane may be put into a container that contains water to recover the acid that passes through the dialysis membrane and use it as a recycled acid. In addition, water may be evaporated from the graphene oxide solution that remains in the dialysis membrane to thereby recover graphene oxide.

Next, in a process 34, a recycling oxidation process reusing the recovered acid solution may be performed. In particular, in the process 34, graphene oxide may be formed by oxidizing newly supplied graphite in a mixed solution including the recovered acid solution and the newly supplied graphite to oxidize the newly supplied graphite while applying microwaves to the mixed solution.

The mixed solution may further include an oxidant. In some embodiments, at least part of the oxidant required in the recycling oxidation process may be newly supplied). In some other embodiments, even when the recovered acid solution includes an oxidant, a specific amount of an oxidant that is required for recycling oxidation reaction may be further added to the mixed solution before the recycling oxidation process. In the recycling oxidation process according to process 34, newly supplied graphite may be oxidized using the recovered acid solution and a newly added oxidant. A detailed description of the oxidant may be the same as described above with reference to FIG. 1, and thus is not repeated here.

To oxidize graphite according to the recycling oxidation process 34, first and second oxidation processes according to the processes 12 and 24 of FIG. 2, respectively, may be sequentially performed.

In some embodiments, in the process 34, microwaves of about 100 W to about 800 W may be applied to the mixed solution of the recovered acid solution and newly supplied graphite for about 1 minute to about 60 minutes. Methods of applying microwaves to oxidize graphite in the recycling oxidation process (process 34) will be described in greater detail with reference to FIGS. 5A to 5E.

As a result of oxidizing graphite according to the process 34, graphene oxide having a structure that includes several to tens layers of sp² hybridized carbon sheet may be obtained. For example, the graphene oxide that results from the process 34 may have a structure that includes about 1 to 10 layers of sp² hybridized carbon sheet.

In a process 36, it is determined whether the number of times the recycling process 30 that includes the processes 32 and 34 performed up to that point is equal to a desired number of times the recycling process that includes the processes 32 and 34 is to be repeated. In some embodiments, the recycling process 30 that includes the processes 32 and 34 may be repeated about 1 to 10 times, but is not limited thereto. For example, the recycling process 30 that includes the processes 32 and 34 may be repeated about 10 or more times if required.

In some embodiments, an acid solution that was used in a preceding graphite oxidation process may be reused in a following graphite oxidation process, so that the amount of acid that is used during the entire graphite oxidation process may be reduced by about two to tens times. The time it takes for graphite oxidation reaction may be reduced by performing graphite oxidation processes using microwaves. Consequently, this may improve productivity and thus enable mass production of graphene oxide.

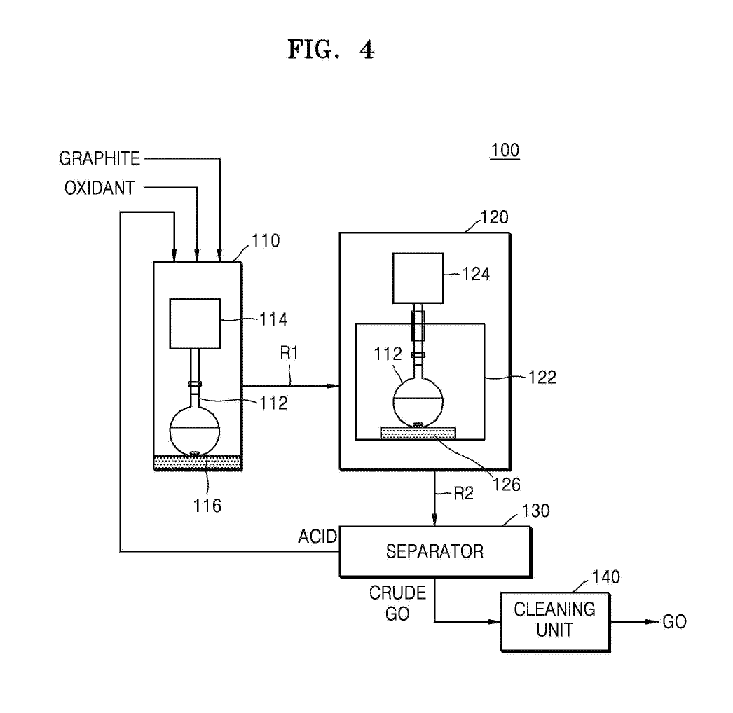

FIG. 4 is a schematic view of a graphene oxide forming apparatus 100 according to an exemplary embodiment of the present disclosure for forming graphene oxide according to the above-described embodiments.

The graphene oxide forming apparatus 100 may used in a process of oxidizing graphite while applying microwaves according to the process 10 of FIG. 1 and the process 34 of FIG. 3. In FIG. 4, moving pathways of reactants and reaction products and a recycling pathway of acid solution in the graphene oxide forming apparatus 100 are also illustrated.

The graphene oxide forming apparatus 100 may include an initial reaction unit 110, a microwave system 120, a separator 130, and a cleaning unit 140.

The initial reaction unit 110 may be used in, for example, a graphite oxidation process, and in particular, in a first oxidation process (corresponding to the process 12 of FIG. 2) of oxidizing part of graphite.

The initial reaction unit 110 may include a container 112 for a mixture of reactants that are required to oxidize graphite, a cooler 114 for controlling the temperature of the mixed solution to prevent overheating of the mixed solution, and a stirrer 116 for stirring the mixed solution. The cooler 114 in the initial reaction unit 110 may control the temperature of the mixed solution in the initial reaction unit 110 to not exceed 50° C.

The microwave system 120 may be used to perform a second oxidation process (corresponding to the process 14 of FIG. 2) on an intermediate product R1 that results from the first oxidation process. The intermediate product R1 may be moved, while being kept in the container 112, into the microwave system 120 from the initial reaction unit 110.

The microwave system 120 may include a microwave application unit 122, a cooler 124, and a stirrer 126. The stirrer 126 may be omitted if deemed not necessary.

While microwaves are applied to the mixed solution in the microwave application unit 122, the temperature of the mixed solution may be controlled using the cooler 124 to not exceed 60° C. While microwaves are applied to the mixed solution in the microwave application unit 122, the mixed solution may be stirred using the stirrer 126.

An intermediate product R2 that results from the second oxidation process performed in the microwave system 120 may be separated into an acid solution (ACID) and a crude graphene oxide product (CRUDE GO) by the separator 130. In some embodiments, the separator 130 may include a centrifuge, a filter, or a dialysis membrane.

The crude graphene oxide product (CRUDE GO) may be washed in the cleaning unit 140 to obtain graphene oxide (GO) as a final product.

In some embodiments, the cleaning unit 140 may include a cleaning bath for cleaning with hydrochloric acid and/or deionized water, a centrifuge, a dryer, and a clean bench.

The acid solution (ACID) recovered in the separator 130 may be fed back into the initial reaction unit 110. In the initial reaction unit 110, a recycling oxidation process may be performed on a mixed solution of the acid solution (ACID) recovered using the separator 130, an oxidant, and graphite in a similar manner as described above with reference to the process 30 of FIG. 1.

Although the graphene oxide forming apparatus 100 according to an exemplary embodiment and an exemplary graphene oxide formation method using the graphene oxide forming apparatus 100 are described above, embodiments of the present disclosure are not limited thereto, various changes in form and details may be made in the above-described embodiments without departing from the spirit and scope of the present disclosure.

FIGS. 5A to 5E are graphs for describing various methods of applying microwaves to graphite-including mixed solution in a graphene oxide formation process, according to embodiments of the present disclosure. The exemplary microwave application methods according to FIGS. 5A to 5E may be applicable in the process 10 of FIG. 1, the process 14 of FIG. 2, and/or the process 34 of FIG. 3.

In some embodiments, microwaves P1 with a power level that is constant with time as illustrated in FIG. 5A may be continuously applied to the mixed solution.

In some embodiments, microwaves P2 with a power level that increases with time as illustrated in FIG. 5B may be continuously applied the mixed solution.

In some other embodiments, microwaves P3 with a power level that increases stepwise with time as illustrated in FIG. 5C may be continuously applied to the mixed solution.

In some other embodiments, microwaves P4 are applied in a pulsed mode where the power of microwaves is alternately turned on and off to alternate a microwave application period and a microwave pause period as illustrated in FIG. 5D. When microwaves are applied in such a pulsed mode, a temperature rise of the mixed solution due to oxidation reaction may be comparatively easily suppressed. Accordingly, reduction reaction of graphene oxide that may likely occur when the temperature of the mixed solution rises too high during oxidation reaction may be effectively prevented.

In some other embodiments, a process of applying microwaves P5 may be performed in a manner as illustrated in FIG. 5E. In particular, the process of applying microwaves P5 may include a first microwave application process I of continuously applying microwaves P5-1 with a power level that increases with time, a second microwave application process II of continuously applying microwaves P5-2 with a power level that is constant with time, and a third microwave application process III of continuously applying microwaves P5-3 with a power level that decreases with time.

A target graphene oxide product may be obtained in a comparatively short time by oxidizing graphite under temperature conditions controlled to not exceed 60° C. while applying microwaves in any of the application manners illustrated in FIGS. 5A to 5E. Accordingly, permeation of the acid solution into graphene oxide during the oxidation reaction may be suppressed, and it may also be easy to separate the acid solution from the graphene oxide after the oxidation reaction. In addition, the oxidation reaction takes place under a comparatively low temperature condition that does not exceed 60° C., and thus reduction of the obtained graphene oxide may be prevented. Accordingly, the yield of graphene oxide may be increased.

One or more embodiments of the present disclosure will now be described in detail with reference to the following examples, including preparation examples of graphene oxide. However, these examples are only for illustrative purposes and are not intended to limit the scope of the one or more embodiments of the present disclosure.

### Preparation Example 1

After 1 g of graphite powder was added to a mixture of 120 mL of sulfuric acid (H₂SO₄) and 14 mL of phosphoric acid (H₃PO₄) in a reaction container, 6 g of potassium permanganate (KMnO₄) was slowly added thereto and stirred for about 5 minutes while maintaining the temperature at about 8° C.

The reaction container was put into a microwave system that was kept at about 40° C., and then microwaves of about 500 W were applied to the mixture for about 20 minutes to induce oxidation reaction of graphite.

The resulting oxidation reaction product was cooled down to room temperature, and then poured onto ice together with 2 mL of a 30% hydrogen peroxide (H₂O₂) to obtain a cooled graphene oxide solution.

The obtained graphene oxide solution was centrifuged at about 6,000 rpm for about 90 minutes to separate the obtained graphene oxide solution into the acid solution and a crude graphene oxide product.

Next, a recycling process of oxidizing graphite through a recycling oxidation process using the separated acid solution was repeated 7 times to further yield the crude graphene oxide product as repeated 7 times. In each of the seven recycling oxidation processes, after the acid solution used in the preceding graphene oxide formation process was recovered and added into the reaction container, 1 g of graphite was added to the reaction container, and then 6 g of potassium permanganate was slowly added to the reaction container, followed by stirring for about 5 minutes while maintaining the temperature at about 8° C. and oxidizing graphite while applying microwaves in the same manner as in the first oxidation process.

Subsequently, graphite was oxidized while applying microwaves in the same manner as in the oxidation process for obtaining the first graphene oxide.

About 1 L of distilled water was added to the resulting crude graphene oxide product obtained through the oxidation processes as described above, and stirred for about 2 hours, followed by adding about 2 mL of a 10% H₂O₂ solution to terminate the reaction, thereby obtaining brightly yellow graphene oxide.

The resulting product was centrifuged at about 6000 rpm for about 90 minutes to collect the precipitate. A 10% HCl was added to the collected precipitate, stirred for about 2 hours, and then centrifuged at about 6000 rpm for about 90 minutes to collect the precipitate. Deionized water was added to the collected precipitate and centrifuged at about 6000 rpm for about 90 minutes to collect the precipitate. Deionized water was added to the collected precipitate, stirred for about 5 hours, and then centrifuged at about 6000 rpm for about 90 minutes to collect the precipitate. Deionized water was then added to the collected precipitate and centrifuged at about 1000 rpm for about 2 minutes to collect the precipitate. The final collected precipitate was dried in a clean bench to obtain graphene oxide.

### Preparation Example 2

The same processes as in Preparation Example 1 were performed to obtain graphene oxide, except that 1 g of graphite powder and 0.5 g of sodium nitrate were added to 50 mL of sulfuric acid in a reaction container, and then 6 g of potassium permanganate was slowly added thereto and stirred for about 5 minutes in an initial graphite oxidation process.

### Preparation Example 3

The same processes as in Preparation Example 1 were performed to obtain graphene oxide, except that 1 g of graphite powder, 0.5 g of sodium nitrate, and 23 mL of sulfuric acid were put into a reaction container, and stirred in an ice bath, and then 6 g of potassium permanganate was stirred for about 5 minutes in an initial graphite oxidation process.

### Preparation Example 4

After 50 mL of sulfuric acid in a reaction container was heated to about 90° C., 10 g of potassium persulfate (K₂S₂O₈) and 10 g of phosphorus pentoxide (P₂O₅) were added thereto, and cooled down to about 80° C. After 12 g of graphite was added thereto, the resulting mixture was kept at about 80° C. for about 4.5 hours and then distilled with 2 L of deionized water. The resulting product was filtered, washed, and dried in a vacuum oven for about 24 hours, thereby pre-treating the graphite.

460 mL of H₂SO₄ was put into a 2L-Erlenmeyer flask and then cooled down to about 0° C. in an ice bath, followed by adding the pre-treated graphite thereto. While maintaining the temperature of the mixture to not exceed about 0° C., 60 g of KMnO₄ was slowly added to the mixture and stirred for about 5 minutes in an initial graphite oxidation process. Next, the same processes as in Preparation Example 1 were repeated.

### Evaluation Example 1

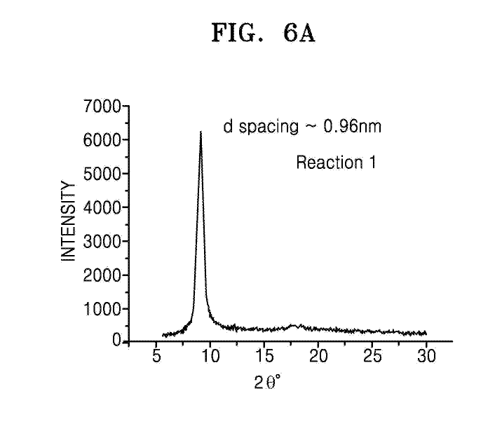

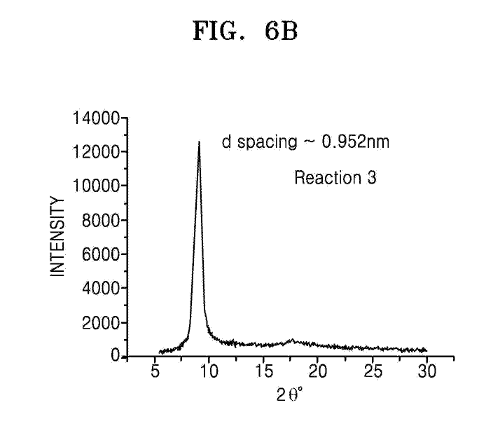

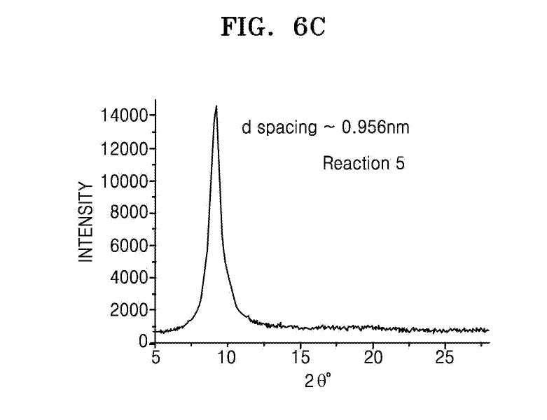

FIGS. 6A to 6C illustrate the results of X-ray diffractometry (XRD) on the graphene oxide obtained in Preparation Example 1.

In particular, FIG. 6A illustrates the results of XRD on a 1^{st} graphene oxide product (Reaction 1) obtained in Preparation Example 1 as a result of an oxidation process performed while applying microwaves before the recycling oxidation process. FIG. 6B illustrates the results of XRD on a 3^{rd} graphene oxide product (Reaction 3) obtained by performing the recycling oxidation process further 2 times using an acid solution separated after the 1^{st} graphene oxide product was obtained. FIG. 6C illustrates the results of XRD on a 5^{th} graphene oxide product (Reaction 5) obtained by performing the recycling oxidation process a further 4 times using the acid solution separated after the 1^{st} graphene oxide product was obtained.

It is found from the XRD results in FIGS. 6A to 6C that the 1^{st} 3^{rd}, and 5^{th} graphene oxide products had an interlayer spacing of about 0.95 nm or greater, and thus reached a high degree of oxidation.

### Evaluation Example 2

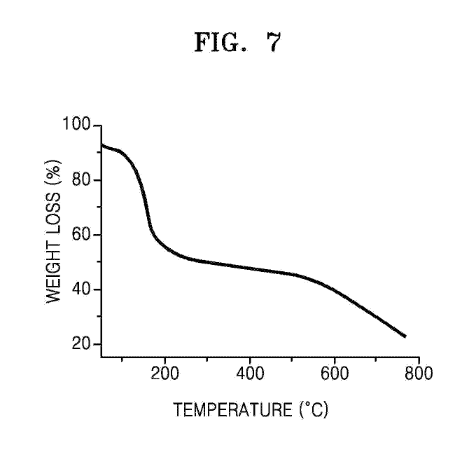

FIG. 7 illustrates the results of thermogravimetric analysis (TGA) on the graphene oxide obtained in Preparation Example 1, and in particular, on an 8^{th} graphene oxide product obtained by performing the recycling oxidation process a further 7 times using the acid solution separated after the 1^{st} graphene oxide product was obtained in Preparation Example 1.

It is found from the results in FIG. 7 that the 8^{th} graphene oxide had a high weight loss, indicating that the 8^{th} graphene oxide product had a high degree of oxidation.

### Evaluation Example 3

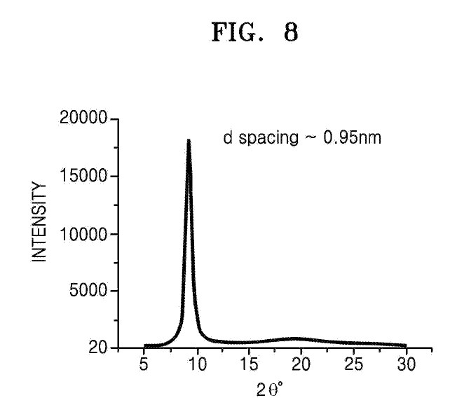

FIG. 8 illustrates the results of XRD on the 8^{th} graphene oxide product obtained in Preparation Example 1.

It is found from the results of FIG. 8 that the 8^{th} graphene oxide product had an interlayer spacing of about 0.95 nm and thus reached a high degree of oxidation, similar to the results in FIGS. 6A to 6C.

### Evaluation Example 4

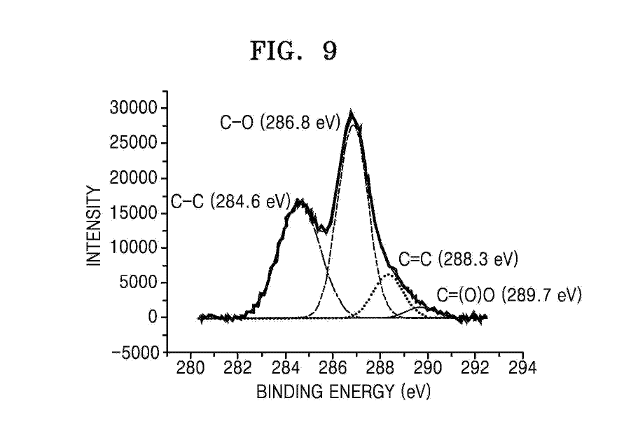

FIG. 9 illustrates X-ray photoelectron spectroscopic (XPS) spectra of the 8^{th} graphene oxide product obtained in Preparation Example 1.

In FIG. 9, peaks from oxygen indicate that sufficient oxidation of the 8^{th} graphene oxide took place.

### Evaluation Example 5

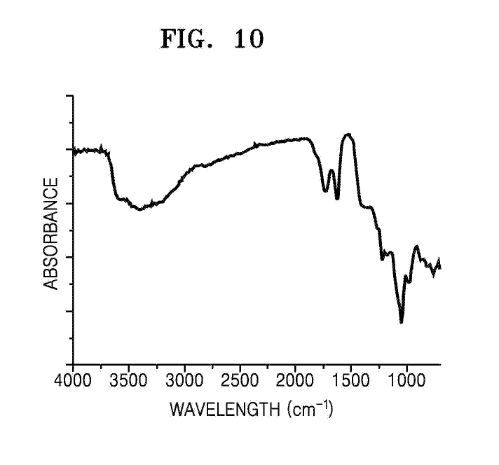

FIG. 10 illustrates Fourier transform infrared (FT-IR) spectra of the 8^{th} graphene oxide product obtained in Preparation Example 1.

In FIG. 10, peaks from oxygen indicate that sufficient oxidation of the 8^{th} graphene oxide took place.

While one or more embodiments of the present invention have been described with reference to the figures, it will be understood by those of ordinary skill in the art that various changes in form and details may be made therein without departing from the spirit and scope of the present invention as defined by the following claims.

### INDUSTRIAL APPLICABILITY

One or more embodiments provide graphene oxide forming methods. Graphene oxide obtained using any of the methods according to the above-described embodiments may be used in electronic devices, for example, in electrodes of a panel used for, for example, a liquid crystal display (LCD), a plasma display, or the like; electrodes of a display device such as a laptop computer, a mobile phone, a touch panel, or the like; electrodes of various batteries such as liquid ion batteries, lithium ion capacitors, fuel cells, thin-filmed solar cells, primary batteries, and secondary batteries; electrodes for electric-discharge machining; parts of semiconductor manufacturing apparatuses; parts of ion injection apparatuses; continuous casting members; heat sinks; heat exchangers, and the like.

1. A method of forming graphene oxide, the method comprising:
oxidizing graphite using an acid so as to form a first reaction product that comprises the graphene oxide;
recovering the acid from the first reaction product; and
oxidizing graphite using the recovered acid to form a recycle-reaction product that comprises the graphene oxide.

2. The method of claim 1, wherein at least one of the forming of the first reaction product and the forming of the recycle-reaction product comprises:
a first oxidization step of oxidizing graphite at a first temperature that does not exceed 50° C.; and
a second oxidization step of oxidizing the graphite while applying microwaves.

3. The method of claim 2, wherein the second oxidization step is performed at a second temperature that does not exceed 60° C.

4. The method of claim 2, wherein the second oxidization step is performed for about 1 minute to about 60 minutes.

5. The method of claim 2, wherein, in the second oxidization step, microwaves with a power level that is constant over time are continuously applied.

6. The method of claim 2, wherein, in the second oxidization step, microwaves with a power level that increases over time are continuously applied.

7. The method of claim 2, wherein, in the second oxidization step, microwaves are applied in a pulsed mode in which a microwave application period and a microwave pause period alternate repeatedly.

8. The method of claim 2, wherein the second oxidization step comprises:
a first microwave application step of continuously applying microwaves with a power level that increases over time;
a second microwave application step of continuously applying microwaves with a power level that is constant over time; and
a third microwave application step of continuously applying microwaves with a power level that decreases over time.

9. The method of claim 2, further comprising cooling a product that results from the second oxidization step before the recovering of the acid.

10. The method of claim 1, wherein the recovering of the acid comprises separating the first reaction product into the graphene oxide and the acid by performing centrifugation.

11. The method of claim 1, wherein the recovering of the acid comprises separating the first reaction product into the graphene oxide and the acid by performing filtration.

12. The method of claim 1, wherein, in the forming of the first reaction product, the graphite is oxidized using the acid and an oxidant to form the graphene oxide, and in the forming of the recycle-reaction product, the graphite is oxidized using the recovered acid and a newly added oxidant to form the graphene oxide.

13. The method of claim 12, wherein at least one of the oxidant and the newly added oxidant is selected from permanganate, ferrate, osmate, ruthenate, chlorate, chlorite, nitrate, osmium tetroxide, ruthenium tetroxide, lead dioxide, hexavalent chromium ions, hydrogen peroxide, silver oxide, ozone, and a combination thereof.

14. The method of claim 1, after the forming of the recycle-reaction product, further comprising repeating at least one time the recovering of the acid from the recycle-reaction product and the oxidizing of the graphite by using the acid recovered from the recycle-reaction product.

15. The method of claim 1, wherein the graphene oxide in the first reaction product and the graphene oxide in the recycle-reaction product have a structure including 1 to 10 layers of sp² hybridized carbon sheet.

16. The method of claim 1, wherein the acid comprises at least one selected from sulfuric acid, phosphoric acid, sodium nitrate, potassium persulfate, phosphorus pentoxide, chlorosulfonic acid, fluorosulfonic acid, oleum, and acetic acid.

17. A method of forming graphene oxide, the method comprising:
a first step of forming the graphene oxide by oxidizing graphite in a mixed solution that includes an acid solution and the graphite while applying microwaves to the mixed solution; and
a second step of forming graphene oxide by oxidizing newly supplied graphite using the acid solution recovered from a resulting product of the first step,
wherein the second step comprises alternately repeating a recovery step of recovering the acid solution from the resulting product of a preceding step, and a recycling oxidation step of forming the graphene oxide by oxidizing newly supplied graphite while applying microwaves to a mixed solution that includes the recovered acid solution and the newly supplied graphite.

18. The method of claim 17, wherein, in at least one of the first step and the second step, microwaves of about 100 W to about 800 W are applied to the mixed solution for about 1 minute to about 60 minutes.

19. The method of claim 17, wherein the first step and the second step each comprises:
a first oxidization step of stirring the mixed solution at a first temperature that does not exceed 50° C.; and
a second oxidization step of applying microwaves to the mixed solution obtained from the first oxidation step at a second temperature that does not exceed 60° C.

20. The method of claim 17, wherein the first oxidization step and the second oxidization step are each performed for about 1 minute to about 60 minutes.
